(19) United States
(12) Patent Application Publication
(10) Pub. No.: US 2008/0053109 A1
(43) Pub. Date: Mar. 6, 2008

(54) Self-activated cooling device for beverage containers

(75) Inventors: Roger B. Quincy, Cumming, GA (US); Robert D. Wright, Peachtree City, GA (US)

Correspondence Address: DORITY & MANNING, P.A., POST OFFICE BOX 1449, GREENVILLE, SC, 29602-1449, US

(73) Assignee: KIMBERLY-CLARK WORLDWIDE, INC.

(21) Appl. No.: 11/512,747

(22) Filed: Aug. 30, 2006

(51) Int. Cl. F25D 5/00; F17C 13/00

(52) U.S. Cl. 62/4; 62/457.9

(57) ABSTRACT

A cooling device for beverage containers includes a shell member having dimensions so as to encircle a beverage container. In use, the shell member has an outer face and an inner face disposed against the beverage container. The shell member defines an interior space, and a first cooling substrate is disposed within this interior space. The cooling substrate includes a web having a generally uniform application of a first cooling composition applied thereto, the cooling composition being activated by contact with an aqueous liquid. An aqueous liquid source is disposed within the interior space and is separated from the first cooling substrate by a barrier member. The cooling device is activated by manual manipulation to breach the barrier member, whereby liquid from the liquid source moves within the interior space to contact and activate the cooling composition, and generate a cooling reaction.

### BACKGROUND OF THE INVENTION

Thermal wraps, sleeves, and other devices specifically designed to wrap around or receive a beverage container are well known. These devices are typically made of any one or combination of conformable thermal insulating materials. Although useful as insulators, these devices have no ability to actually reduce the temperature of the beverage within the container.

Conventional self-contained cooling packs are also known and used for a wide variety of purposes. For example, cooling packs are available that contain particles of a cooling agent, such as urea or ammonium nitrate, separated from a compartment or pouch that contains an aqueous liquid. Typically, the cooling function is achieved by breaking or rupturing a barrier or seal between the liquid and cooling agent particles. As the particles dissolve in the aqueous liquid, heat is absorbed and a cooling effect is generated. Such devices are widely used in the medical industry, and in the transport and storage of food products.

U.S. Pat. No. 6,099,555 describes a gelling cold pack that includes a gelling agent, such as starch, adhered as a liquid permeable non-continuous coating to a composite particulate “cold-generating” material that interacts with a liquid to produce cold. The cold-generating material may be one of a number of ammonium salts, tin, cobalt or nickel salts, alkali metal salts, or an organic compound such as urea. The gelling material is applied to the cold-generating particles by spraying, dipping, brushing or with the use of an adhesive material. The coated particles are housed in liquid-impermeable, heat-conducting zones of a disposable container, with at least one other zone containing a liquid. The cold pack is activated by rupturing a frangible membrane between the zones. These and similar cold packs are designed to be placed into containers to cool food or drinks. Such cold packs also have a number of medical applications, including therapeutic devices for relief from overheating, wound care, treatment of strained muscles, joints or ligaments, or to treat or prevent heat exhaustion.

Cold pack technology, however, has not had widespread application to thermal beverage sleeves or wraps. The industry is in need of an efficient and economically feasible cooling device specifically designed as a disposable sleeve or wrap for beverage containers, with the device also functioning as a thermal cooling device capable of reducing the temperature of the beverage and keeping previously chilled beverages cooler for longer periods of time. The present invention relates to a novel construction of such a device.

### SUMMARY OF THE INVENTION

Objects and advantages of the invention will be set forth in part in the following description, or may be obvious from the description, or may be learned through practice of the invention.

In accordance with one embodiment of the present invention, a cooling device for beverage containers is provided. The device includes a shell member having dimensions so as to receive a desired beverage container inserted therein, and includes an outer face and an inner face that is disposed against the beverage container in use of the device. A first cooling substrate is disposed within an interior space in the shell member. The cooling substrate includes a web having a generally uniform application of a first cooling composition applied thereto, the cooling composition being activated by contact with an aqueous liquid. This web may be a hydrophobic material. A source of aqueous liquid is disposed within the interior space of the shell and is separated from the first cooling substrate by a barrier member, such as a breakable wall, frangible seal, bladder or other breakable liquid container inserted into the shell member, or other suitable liquid source that is maintained separate from the cooling substrate. The device may be activated by simple manual manipulation of the shell member to break, rupture, or otherwise breach the barrier member to release the liquid from the liquid source. As the liquid moves through the interior space and contacts the cooling substrate, the cooling reaction is generated. The manual manipulation may include, for example, any combination of twisting, pulling, compressing, squeezing, or bunching of the shell member.

In one embodiment, the shell member comprises a generally cylindrical configuration having dimensions such that the beverage container is slid into the shell member. A bottom wall may be provided such that the device defines a closed-end configuration. In this embodiment, the shell member may have sufficient rigidity to maintain its configuration after removal of the beverage container. For example, the shell member may include a layer of foam insulation material, or other material of sufficient thickness and rigidity such that the device maintains it open-ended configuration without a beverage container being inserted therein.

In an alternate embodiment, the shell member is defined by a flexible sleeve member that generally collapses upon removal of the beverage container such that the device assumes a generally flat or folded configuration when not in use. In this embodiment, the shell member may be formed by any combination of flexible and conformable materials. The first cooling substrate is also formed from a flexible material so as to conform with the flexible sleeve. The flexible sleeve may be a planar component with an attaching mechanism at one or both of the ends thereof so that the sleeve can be wrapped around and attached to the beverage container. In still another embodiment, the flexible sleeve may be formed into a continuous loop that is opened by the user to insert a beverage container into the device.

The cooling substrate may take on any size, shape, number, and configuration within the interior space of the shell member. For example, the cooling substrate may have dimensions essentially matching the interior length and width dimensions of the shell member. It may be desired that the substrate at least have a length dimension to completely wrap or encircle the intended beverage container inserted into the device. The cooling substrate may be a separate web material that is placed into the interior space of the shell member. Multiple substrates may be provided and separated by a material layer that serves to conduct fluid between the substrates. Alternatively, the cooling substrate may be defined by an interior layer of the shell member. For example, the shell member may be a laminate material having a nonwoven material layer exposed within the interior of the shell. This nonwoven layer may have the cooling composition applied thereto and also function as the cooling substrate.

In a particular embodiment, the cooling substrate may be a dual layer bonded carded web material, as described below.

The device may include one or a combination of different cooling substrates having the same or different cooling compositions. For example, the first cooling composition may be applied to a first substrate to provide the device with a first set of cooling characteristics. A second cooling composition may be applied to the same substrate, or a second substrate, to provide a different set of cooling characteristics. Alternatively, the same cooling composition may be applied in different concentration levels to the same or different substrates to provide different sets of cooling characteristics. In a particular embodiment, a first set of cooling characteristics may be desired to deliver an initial rapid and pronounced decrease in temperature, while a second set of cooling characteristics may provide a more gradual and sustained temperature reduction. Any combination of cooling compositions may be utilized in this regard to achieve any desired cooling profile.

The cooling compositions may vary within the scope and spirit of the invention. In one embodiment, the composition may include a particulate cooling agent that is adhered in particulate form to the substrate with an adhesive, binder, or other suitable means. In an alternate embodiment, the cooling composition may be a cooling agent that has been melted and applied by any conventional means to the substrate in liquid form. In still another embodiment, the cooling composition is an aqueous solution coated onto the substrate, wherein the cooling agent re-crystallizes on the substrate upon drying the solution. The solution may include any combination of binder, viscosity modifier, or other component to aid in application of the cooling composition to the substrate.

The liquid source within the interior space of the shell may take on various configurations. For instance, the source may be defined by a liquid-filled compartment defined within the shell, the compartment having a barrier wall or seal that is breached or opened by simple manual manipulation of the device. This compartment may be defined by one or more of the interior surfaces of the shell member. For example, a frangible wall may be attached at the longitudinal ends of the shell member between the opposite interior surfaces of the shell member, with this wall rupturing or breaking upon pressure being applied to the device. In another embodiment, the compartment may be defined entirely by the interior surfaces of the shell member, with a frangible seal between the surfaces separating the liquid compartment from the cooling substrate. In other embodiments, the liquid source includes any combination of separate liquid filled “bladders” or breakable containers placed within the interior of the shell. These bladders may include, for example, vials, pliable pouches, or any other suitable liquid container that is readily opened or breeched by external manual manipulation of the device.

Desirably, the amount of liquid released into the interior space of the shell member is calculated such that essentially all of the liquid is absorbed. In this manner, excess liquid is not held within said interior space after activation of said device.

Other features and aspects of the present invention are described in more detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1A is a perspective and partial cut-away view of an embodiment of a cooling device for beverage containers in accordance with the invention.

FIG. 1B is a perspective view of the embodiment of FIG. 1A wrapped around a beverage container.

FIG. 1C is a cross-sectional view taken along the lines indicated in FIG. 1A.

FIG. 2 is a perspective view of an alternative embodiment of a beverage container cooling device according to the invention.

FIG. 3 is a perspective view of still another embodiment of a molded cooling device for a beverage container in accordance with the invention.

FIG. 4 is a cross-sectional view of a particular embodiment of a cooling device in accordance with the invention.

FIG. 5 is a cross-sectional view of an alternative embodiment of a cooling device in accordance with the invention.

FIG. 6 is a cross-sectional view of still a different embodiment of a cooling device in accordance with the invention.

FIG. 7 is a partial cross-sectional view particularly illustrating an embodiment of a panel member that may be used as a shell member component in accordance with the invention.

FIG. 8 is a time v. temperature chart of the embodiment of Example 1.

### DETAILED DESCRIPTION OF REPRESENTATIVE EMBODIMENTS

Reference now will be made in detail to various embodiments of the invention, one or more examples of which are set forth below. Each example is provided by way of explanation, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention cover such modifications and variations.

Generally speaking, the present invention is directed to a cooling device that is particularly suited as a cooling sleeve or wrap for any manner of beverage container. The device includes a cooling composition that generates a cooling effect upon activation of the device. Through selective control of the cooling agent and supply of aqueous reactant, a desired cooling profile may be achieved in which a reduced temperature is reached quickly and maintained over an extended period of time. For example, a reduced temperature of from about 3° C. to about 10° C. may be achieved in about 2 minutes or less and sustained at a reduced temperature for a time sufficient for a consumer to consume the beverage at a normal consumption rate.

The cooling composition may include any one or combination of known cooling agents that react with an aqueous liquid in a physical reaction that produces cold by the negative heat of dissolution of the agent into the aqueous liquid. For example, the dissolution in water of inorganic salts such as ammonium nitrate, potassium nitrate, ammonium sulfate, and ammonium chloride produce cold. Further useful cooling agents are organic materials such as urea, and other inorganic salts such as ammonium bromide, ammonium iodide, potassium chloride, tin chloride dihydrate, diamminecobalt, dichlorocobalt hexahydrate, and nickel nitrate hexahydrate. A preferred agent is particulate ammonium nitrate, commercially available in the form of a low or high-density prill. The low-density prills may also include a clay binder, such as kaolin, at a low percentage by weight (from about 0.5 to about 5% by weight, often from about 1 to 3% by weight). In the aqueous-based cooling device, the cooling agent may be present from about 50 to about 150 grams per 100 mL of water, preferably from about 75 to about 140 grams per 100 mL of water.

In a particular embodiment, the cooling composition is applied in solution form to the cooling substrate, wherein the cooling agent recrystallizes on the substrate upon drying the solution. The solution may also employ a binder for enhancing the durability of the composition when applied to the cooling substrate. The binder may also serve as an adhesive for bonding one substrate to another substrate. Generally speaking, any of a variety of binders may be used in the cooling composition of the present invention. Suitable binders may include, for instance, those that become insoluble in water upon crosslinking. Crosslinking may be achieved in a variety of ways, including by reaction of the binder with a polyfunctional crosslinking agent. Examples of such crosslinking agents include, but are not limited to, dimethylol urea melamine-formaldehyde, urea-formaldehyde, polyamide epichlorohydrin, etc. In some embodiments, a polymer latex may be employed as the binder. Water-soluble organic polymers may also be employed as binders, either alone or in conjunction with the polymer latexes. For example, one class of suitable water-soluble organic polymers is polysaccharides and derivatives thereof.

The concentration of the binder in the cooling composition will generally vary based on the desired properties of the cooling substrate. For example, although relatively high binder concentrations may provide better physical properties for the cooling composition, they may likewise have an adverse effect on other properties, such as the absorptive capacity of the substrate to which it is applied. Conversely, relatively low binder concentrations may reduce the ability of the cooling agent component of the composition to remain affixed on the substrate. Thus, in most embodiments, the binder is present in the cooling composition solution in an amount from about 0.01 wt. % to about 20 wt. %, in some embodiments from about 0.1 wt. % to about 10 wt. %, and in some embodiments, from about 0.5 wt. % to about 5 wt. %.

Viscosity modifiers may be used in the cooling composition, for example, to adjust the viscosity of the coating formulation based on the desired coating process and/or performance of the coated cooling substrate. Suitable viscosity modifiers may include gums, such as xanthan gum. Binders, such as the cellulosic ethers, may also function as suitable viscosity modifiers. When employed, such additional components typically constitute less than about 5 wt. %, in some embodiments less than about 2 wt. %, and in some embodiments, from about 0.001 wt. % to about 1 wt. % of the coating.

Any type of substrate may be coated with the cooling composition in accordance with the present invention. For instance, nonwoven fabrics, woven fabrics, knit fabrics, paper web, film, absorbent foams, etc., may be applied with the cooling composition. When utilized, nonwoven fabrics may include, but are not limited to, spunbonded webs (apertured or non-apertured), meltblown webs, bonded carded webs, air-laid webs, coform webs, hydraulically entangled webs, and so forth.

In certain embodiments, the substrate is an absorbent material that captures the liquid from the liquid source to generate a uniform cooling effect in the device regardless of orientation or position of the shell member. The absorbent material may include an absorbent web formed using any technique, such as a dry-forming technique, an airlaying technique, a carding technique, a meltblown or spunbond technique, a wet-forming technique, a foam-forming technique, etc. The absorbent layer may contain cellulosic fibers, such as natural and/or synthetic fluff pulp fibers. The fluff pulp fibers may be kraft pulp, sulfite pulp, thermomechanical pulp, etc. In addition, the fluff pulp fibers may include high-average fiber length pulp, low-average fiber length pulp, or mixtures of the same. One example of suitable high-average length fluff pulp fibers includes softwood kraft pulp fibers.

In a particular embodiment, the substrate is a dual layer bonded carded web material of type used, for example, as surge layer materials in absorbent articles. Examples of these dual layer bonded carded webs may be found in U.S. Pat. No. 5,820,973 Heterogeneous Surge Material for Absorbent Articles, incorporated herein by reference for all purposes.

To apply the cooling composition to the substrate, the components may initially be dissolved or dispersed in a solvent. For example, one or more of the above-mentioned components may be mixed with a solvent, either sequentially or simultaneously, to form a coating formulation that may be easily applied to a substrate. Any solvent capable of dispersing or dissolving the components is suitable, for example water; alcohols such as ethanol or methanol; dimethylformamide; dimethyl sulfoxide; hydrocarbons such as pentane, butane, heptane, hexane, toluene and xylene; ethers such as diethyl ether and tetrahydrofuran; ketones and aldehydes such as acetone and methyl ethyl ketone; acids such as acetic acid and formic acid; and halogenated solvents such as dichloromethane and carbon tetrachloride; as well as mixtures thereof. In one particular embodiment, for example, water is used as the solvent so that an aqueous coating formulation is formed. Although the actual concentration of solvent (e.g., water) employed will generally depend on the type and amount of cooling agent and the substrate on which it is applied, it is nonetheless typically present in an amount from about 10 wt. % to about 80 wt. % of the coating formulation. The amount of the other components added to the coating formulation may vary depending on the amount of cold desired, the wet pick-up of the application method utilized, etc.

The viscosity of the cooling composition formulation may be varied in accordance with the coating method to achieve the desired amount of the composition on the substrate. For instance, lower viscosities may be employed for saturation coating techniques (e.g., dip-coating), while higher viscosities may be employed for drop-coating techniques. If desired, thickeners or other viscosity modifiers may be employed in the coating formulation to increase or decrease viscosity.

The cooling composition formulation may be applied to a substrate using any conventional technique, such as bar, roll, knife, curtain, print (e.g., rotogravure), spray, slot-die, drop-coating, or dip-coating techniques. The materials that form the substrate (e.g., fibers) may be coated before and/or after incorporation into the substrate. The composition may be applied to one or both surfaces of the substrate. For example, the composition may be present only on the surface of the substrate that is adjacent the inner face of the shell member, or on both surfaces of the substrate. In addition, the composition may cover an entire surface of the substrate, or may only cover a portion of the surface.

Regardless of the manner in which the cooling composition is applied, the resulting cooling substrate is typically heated to a certain temperature to remove the solvent and recrystallize the cooling agent. For example, the thermal substrate may be heated to a temperature of at least about 100° C., in some embodiments at least about 110° C., and in some embodiments, at least about 120° C. In this manner, the resulting dried cooling composition is anhydrous, i.e., generally free of water. By minimizing the amount of moisture, the composition is less likely to react prematurely and generate cold. Thus, the composition may remain inactive for extended periods until it is desired to use the cooling device.

The thickness of the cooling composition may also vary. For example, the thickness may range from about 0.01 millimeters to about 5 millimeters, in some embodiments, from about 0.01 millimeters to about 3 millimeters, and in some embodiments, from about 0.1 millimeters to about 2 millimeters. In some cases, a relatively thin coating may be employed (e.g., from about 0.01 millimeters to about 0.5 millimeters). Such a thin coating may enhance the flexibility of the substrate.

To maintain absorbency, porosity, flexibility, and/or some other characteristic of the substrate, it may sometimes be desired to apply the cooling composition so as to cover less than 100%, in some embodiments from about 10% to about 80%, and in some embodiments, from about 20% to about 60% of the area of one or more surfaces of the substrate. For instance, in one particular embodiment, the cooling composition is applied to the substrate in a preselected pattern (e.g., reticular pattern, diamond-shaped grid, dots, and so forth). Such a patterned composition may provide sufficient cooling to the substrate without covering a substantial portion of the surface area of the substrate. This may be desired to optimize flexibility, absorbency, or other characteristics of the substrate. It should be understood, however, that the coating may also be applied uniformly to one or more surfaces of the substrate.

In addition, a patterned application of the cooling composition may also provide different cooling characteristics (functionality) to each zone. For example, in one embodiment, the substrate is treated with two or more patterns of coated regions that may or may not overlap. The regions may be on the same or different surfaces of the substrate. One region may be coated with a first cooling composition, while another region is coated with a second different cooling composition. The first region may provide a rapid but relatively short cooling profile, while the second region generates a gradual but sustained cooling profile. In embodiments wherein different cooling compositions are applied to the same substrate, care must be taken to separate the compositions during application and drying. In alternate embodiments, the different cooling compositions may be applied to different substrates.

Other substrates may also be employed to improve or enhance application of cooling through the shell member to the beverage container. For example, any number or combination of thermal conductive and/or insulation material layers may be disposed within the interior space of the shell member. These materials may be employed to provide cooling to substantially only the inner face of the shell member that is placed against the beverage container. In an alternative arrangement, the shell member is reversible such that either face may provide the desired cooling effect, and the materials may thus be disposed within the shell member to provide cooling to both faces of the shell member.

For example, the thermal device may employ a thermally conductive layer to help distribute the generated cold toward the beverage container along the x-y plane of the device, thereby improving the uniformity of cold application. Although any thermally conductive material may generally be employed, it is often desired that the selected material be flexible and conformable. Suitable conformable materials include, for instance, fibrous materials (e.g., nonwoven webs), films, and so forth. For example, the thermally conductive layer may contain a nonwoven laminate, such as a spunbond/meltblown/spunbond (“SMS”) laminate. The SMS laminate is formed by well-known methods, such as described in U.S. Pat. No. 5,213,881 to Timmons, et al., which is incorporated herein its entirety by reference thereto for all purposes. A variety of techniques may be employed to provide conductivity to the thermally conductive layer. For example, a metallic coating may be utilized to provide conductivity. Metals suitable for such a purpose include, but are not limited to, copper, silver, nickel, zinc, tin, palladium, lead, copper, aluminum, molybdenum, titanium, iron, and so forth. Metallic coatings may be formed on a material using any of a variety of known techniques, such as vacuum evaporation, electrolytic plating, etc. For instance, U.S. Pat. No. 5,656,355 to Cohen; U.S. Pat. No. 5,599,585 to Cohen; U.S. Pat. No. 5,562,994 to Abba, et al.; and U.S. Pat. No. 5,316,837 to Cohen, which are incorporated herein their entirety by reference thereto for all purposes, describes suitable techniques for depositing a metal coating onto a material.

Besides a metal coating, still other techniques may be employed to provide conductivity. For example, an additive may be incorporated into the material (e.g., fibers, film, etc.) to enhance conductivity. Examples of such additives include, but are not limited to, carbon fillers, such as carbon fibers and powders; metallic fillers, such as copper powder, steel, aluminum powder, and aluminum flakes; and ceramic fillers, such as boron nitride, aluminum nitride, and aluminum oxide. Commercially available examples of suitable conductive materials include, for instance, thermally conductive compounds available from LNP Engineering Plastics, Inc. of Exton, Pa. under the name Konduit® or from Cool Polymers of Warwick, R.I. under the name CoolPoly®. Although several examples of conductive materials have been described above, it should be understood that any known thermally conductive material may be generally used in the present invention.

As mentioned, an insulation layer may be employed to inhibit loss of cold to the outer environment. The insulation layer may be within the interior of the shell member, or attached to the exterior of the outer face of the shell member. Any known insulation material may be employed in this regard. If desired, the selected insulation material may be fibrous in nature to improve the overall conformability of the thermal device. The fibrous material may possess high loft to enhance its insulative properties. Suitable high loft materials may include porous woven materials, porous nonwoven materials, etc. Particularly suitable high loft materials are nonwoven multicomponent (e.g., bicomponent) polymeric webs. For example, the multicomponent polymers of such webs may be mechanically or chemically crimped to increase loft. Examples of suitable high loft materials are described in more detail in U.S. Pat. No. 5,382,400 to Pike, et al.; U.S. Pat. No. 5,418,945 to Pike, et al. and U.S. Pat. No. 5,906,879 to Huntoon, et al., which are incorporated herein in their entirety by reference thereto for all purposes. Still other suitable materials for use as an insulation material are described in U.S. Pat. No. 6,197,045 to Carson, which is incorporated herein in its entirety by reference thereto for all purposes.

Various foam materials may be utilized as the insulating foam layer in sleeves according to the invention. A particularly well-suited foam is a styrene based, low-density, open-cell foam made with balanced amounts of one or more surfactants and a plasticizing agent in a foam polymer formula. Thermoplastic elastomers can be added to the foam polymer formula to improve softness, flexibility, elasticity, and resiliency of the foam layer. The open-cell content of the foam is controlled by adjusting the amount of surfactant and/or plasticizing agent included in the foam polymer formulation, and in particular embodiments suited for the present invention, the open-cell content can be at about 80% or greater. The density of the foam is less than about 0.1 g/cc, and desirably less than about 0.07 g/cc (before any compression is applied to meet packaging or use requirements). This particular type of foam is described in detail in the published U.S. Pat. application Ser. No. 10/729881 (Publication No, 20050124709) and U.S. patent application Ser. No. 11/218825 (Publication No. 20060030632), both of which are incorporated herein for all purposes.

In addition, substrates may be employed to aid in distributing liquid from the liquid source throughout the interior of the shell member to the cooling substrate to produce a more even cooling effect. Such materials may include, for example, a nonwoven web, a film, a channeled or embossed substrate, and any other material that serves to wick or channel liquid from one area to another without absorbing or retaining the liquid to any significant degree.

The shell member is not limited to any particular shape or material. In particular embodiments, the shell member is liquid impervious and comprises a thin, flexible, envelope-type structure. The shell member is formed of materials that are not deleteriously affected by any of the contents of the cooling composition, and which are resistant to the cold temperature produced by the device. The shell member may include a thermally conductive material at one or both interior surfaces. Such materials can be polymeric, and include ionomer film (for example, SURLYN available from DuPont), polyethylene, polypropylene, polyester (such as MYLAR film obtainable from DuPont) aluminum, aluminized polymer film, and other conventional plastic or other packaging materials suitable for containing cooled liquids, such as rubber, vinyl, or vinyl-coated fabric. In a preferred embodiment, the thermally conductive material is a metal foil, such as one composed substantially of aluminum or copper, or a metallized plastic film such as aluminized polyester.

An insulation material layer may be provided at the outer face of the shell member to insulate the user from the cold. This layer may also serve to present a soft, compliant, and functional surface to the user. This material may be, for example, a nonwoven material that is creped, embossed, textured, or otherwise presents a grip-enhanced surface to the user.

The shell member may be formed by a laminate material that includes a thermally conductive material laminated to an insulation layer material. For example, the shell member may be a laminate of a nonwoven insulation material and a thermally conductive film.

The shell member desirably has a thickness that permits the shell member to readily conform to the shape of the beverage container it surrounds. The shell member may be formed by separate material layers that are bonded together at the edges to form a hermetically sealed, substantially planar envelope. The edges of the material are bonded together by any suitable means, for example, soldering, heat sealing, ultrasonic welding, solvent welding, fold sealing, or the use of adhesives.

In still an alternate embodiment, the shell member may include a more rigid layer that defines an open-ended container having dimensions to receive a desired beverage container. This layer may be, for example, an open or closed cell foam material. The interior space for receipt of the cooling substrate may be defined within this material, or may be defined between the inner surface (surface that faces the container) of the foam and a thermally conductive layer that is attached to the interior surface.

The activating liquid is supplied by the internal liquid source. In a particular embodiment, this source is defined by a compartment within the shell member that is opened or breached by manual manipulation of the shell member by the user. The barrier may be a wall formed of a material that allows its rupture, break, perforate, or otherwise be compromised by manual deformation of the shell member, for example upon the user compressing or twisting the shell member prior to placing the device around a beverage container. Any number and configuration of barrier walls may be formed in the interior of the shell member depending on the size of the thermal device and the volume of liquid to be delivered. In one embodiment, the barrier comprises a brittle or weakened wall extending between the interior surfaces of the shell member. In another embodiment, the barrier may be a frangible seal between the opposing interior faces of the shell member.

In other embodiments, the liquid source includes any combination of separate liquid filled “bladders” placed within the interior of the shell. These bladders may include, for example, liquid vials, pliable pouches, or any other suitable liquid container that is readily opened, broken, or otherwise breeched by external manual manipulation of the device.

It may be desired that the shell member have elastic properties, particularly in the embodiments wherein the shell member defines a closed cylindrical sleeve. In this regard, the shell member may be formed of any combination of conventional liquid impermeable elastomeric materials, such as an elastomeric film/nonwoven laminate. The elastic component of the laminate can contain elastic strands or sections uniformly or randomly distributed throughout the material. Alternatively, the elastic component can be an elastic film or an elastic nonwoven web. In general, any material known in the art to possess elastomeric characteristics can be used in the present invention as an elastomeric component. Useful elastomeric materials can include, but are not limited to, films, foams, nonwoven materials, etc.

Other exemplary elastomeric materials which may be used include polyurethane elastomeric materials such as, for example, those available under the trademark ESTANE® from B.F. Goodrich & Co. or MORTHANE® from Morton Thiokol Corp., polyester elastomeric materials such as, for example, those available under the trade designation HYTREL® from E.I. DuPont De Nemours & Company, and those known as ARNITEL®, formerly available from Akzo Plastics of Amhem, Holland and now available from DSM of Sittard, Holland.

Another suitable material is a polyester block amide copolymer. Elastomeric polymers can also include copolymers of ethylene and at least one vinyl monomer such as, for example, vinyl acetates, unsaturated aliphatic monocarboxylic acids, and esters of such monocarboxylic acids. The elastomeric copolymers and formation of elastomeric nonwoven webs from those elastomeric copolymers are disclosed in, for example, U.S. Pat. No. 4,803,117.

When incorporating an elastomeric component, such as described above, into a base web, it is often desired that the elastomeric material form an elastic laminate with one or more other layers, such as foams, films, apertured films, and/or nonwoven webs. The elastic laminate generally contains layers that can be bonded together so that at least one of the layers has the characteristics of an elastic polymer. Examples of elastic laminates include, but are not limited to, stretch-bonded laminates and neck-bonded laminates.

The elastic member used in neck-bonded materials, stretch-bonded materials, stretch-bonded laminates, neck-bonded laminates and in other similar laminates can be made from materials, such as described above, that are formed into films, such as a microporous film, fibrous webs, such as a web made from meltblown fibers, spunbond filaments or foams. A film, for example, can be formed by extruding a filled elastomeric polymer and subsequently stretching it to render it microporous.

In one embodiment, the elastic member can be a neck stretched bonded laminate. As used herein, a neck stretched bonded laminate is defined as a laminate made from the combination of a neck-bonded laminate and a stretch-bonded laminate. Examples of necked stretched bonded laminates are disclosed in U.S. Pat. Nos. 5,114,781 and 5,116,662, which are both incorporated herein by reference. Of particular advantage, a necked stretch bonded laminate is stretchable in the machine direction and in a cross machine direction. Further, a neck stretch-bonded laminate can be made with a nonwoven basing that is texturized. In particular, the neck stretched bonded laminate can be made so as to include a nonwoven facing that gathers and becomes bunched so as to form a textured surface.

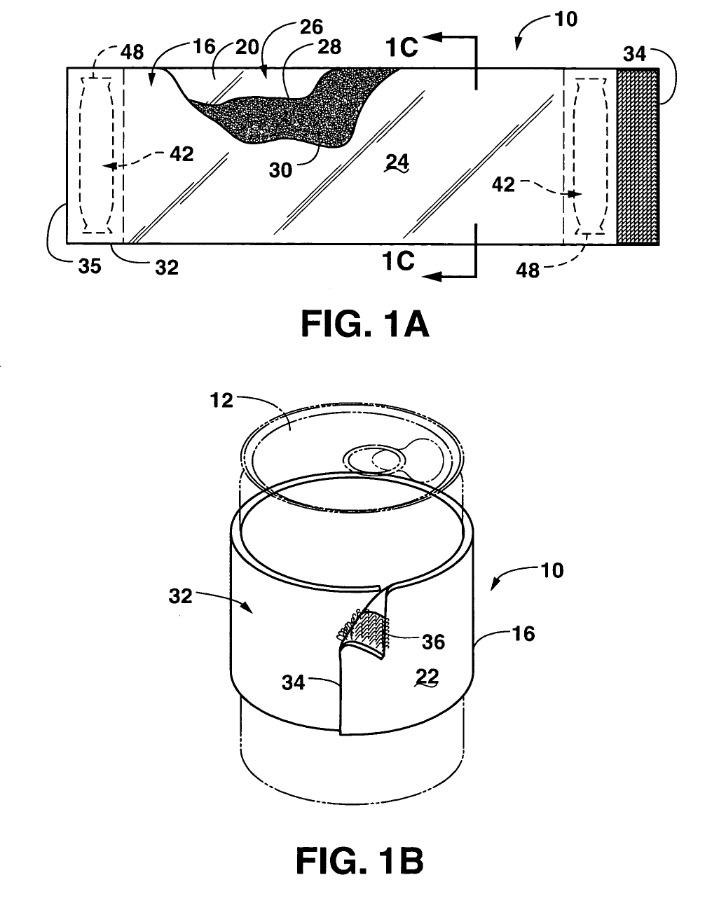

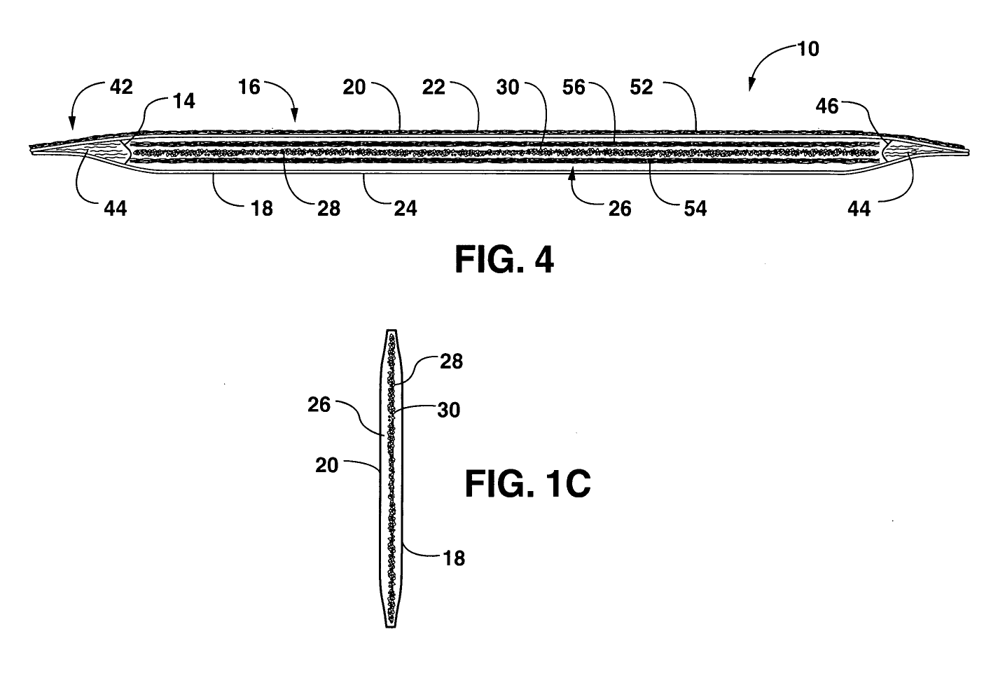

Various embodiments of a cooling device 10 in accordance with the invention are illustrated in the figures. FIGS. 1A, 1B, and 1C illustrate a particular embodiment wherein the cooling device 10 includes a shell member 16 formed from a first panel 18 and an opposite second panel 20. These panel members may be the same material, or different materials. The first panel 18 defines an inner face 24 that is disposed against the beverage container 12 when the sleeve 10 is wrapped around a beverage container, as illustrated in FIG. 1B. The second panel 20 defines an outer face 22 that is grasped by the user. In the particular embodiment illustrated in FIGS. 1A through 1C, the shell member 16 defines a generally flat, planar, flexible sleeve member 32 having opposite ends 34, 35. At one of the ends, or at both ends, any suitable attaching mechanism 36 is provided for securing the sleeve 32 around a beverage 12, as particularly illustrated in FIG. 1B. In the illustrated embodiment, the attaching mechanism 36 is a conventional hook-and-loop type of fastener wherein hooks are provided along the end 34 of the sleeve 32. These hooks engage directly against the outer surface material of the panel 20, or a separate landing zone of hook compatible material may be provided on the panel 20. In alternative embodiments, the attaching mechanism 36 may be a releasable adhesive, mechanical device, and so forth. It should be appreciated that the invention is not limited by any particular type of attaching mechanism for securing the flexible sleeve 32 around a beverage can.

Referring to FIG. 1A, the shell member 16, particularly the panels 18, 20, defines an interior space 26. A cooling substrate 28 is contained within this interior space and includes a cooling composition 30 applied thereto. The cooling substrate 28 may comprise a base material with the cooling composition 30 applied in solution form over essentially the entire surface thereof, as discussed in detail above. Alternatively, the cooling composition 30 may comprise particulate cooling agent component adhered to a base web with use of an adhesive, or the like.

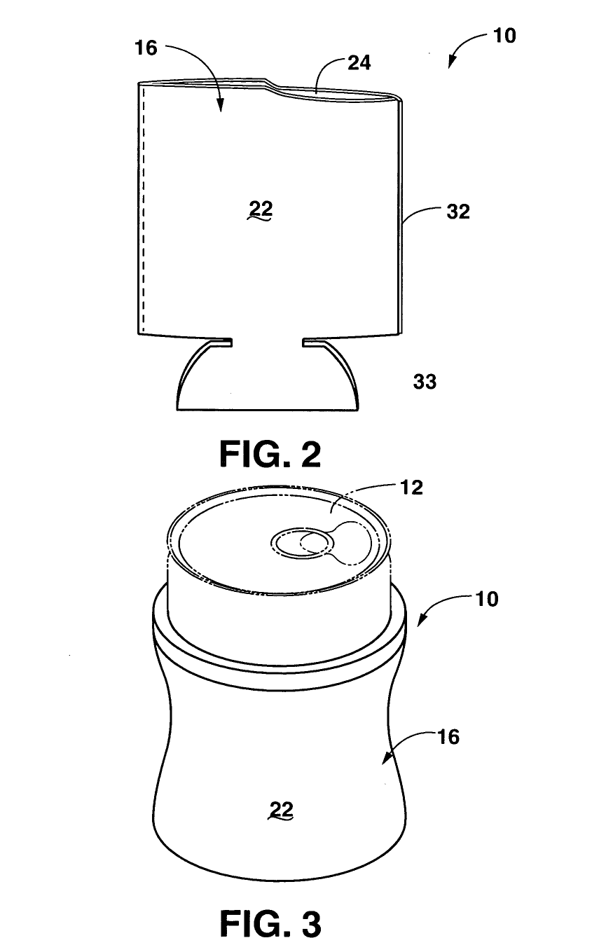

FIG. 2 illustrates an alternative embodiment of a cooling device 10 wherein the shell member 16 is defined by a flexible sleeve member 32 that is formed into a closed-loop configuration. To use this device, the operator manipulates the sleeve member 32 into an open configuration, and subsequently slides a beverage container into the sleeve. The device 10 may include a bottom wall 33 that essentially defines a surface against which the bottom of the beverage container rests in use of the device.

FIG. 3 illustrates an alternative embodiment of a cooling device wherein the shell member 16 is defined by a molded body having sufficient rigidity so as to maintain an open receptacle configuration when the beverage container 12 is removed from the cooling device 10.

It should be appreciated that the cooling device 10 according to the invention is not limited to any particular shape, configuration, or appearance. The unique thermal aspects of the present invention may be incorporated into any conventional style of beverage container insulator or holder.

Referring again to FIG. 1A, the cooling substrate 28 desirably has a length and width dimension so as to completely encircle the beverage can 12 once the sleeve member 32 is applied around the container. In this regard, the substrate 28 may have dimensions corresponding to the width and length dimensions of the interior space 26. It should be appreciated, however, that the invention encompasses alternative embodiments wherein the substrate is discontinuous or does not completely encircle the beverage container.

An aqueous liquid source 42 is disposed within the interior space 26 of the shell member 16. In the embodiment illustrated in FIG. 1A, the liquid source 42 is provided by bladders 48 disposed generally adjacent the opposite ends of the flexible sleeve 32, or at any other location within the interior space 26. The bladders 48 are inserted between the panel members 18, 20, in construction of the cooling device 10. The bladders 48 are filled with an aqueous liquid, such as water, and rupture or burst upon sufficient pressure being applied thereto. To activate the device 10, a user simply grasps and squeezes the sleeve 32 at the ends thereof causing the bladders 48 to rupture and release the liquid contained therein. The liquid is then free to move within the interior space 26 and contact the cooling composition 30 applied to the cooling substrate 28. As discussed in detail above, the cooling composition includes a cooling agent that dissolves in the aqueous liquid and generates a cooling effect. In a desirable embodiment, the base material of the cooling substrate 28 is absorbent and captures the water released from the bladders 48. Desirably, the volume of liquid released from the bladders 48 is sufficient to saturate the absorbent web material of the cooling substrate 28 to ensure a complete and effective cooling reaction, while minimizing excess liquid that may tend to slosh around within the shell member 16.

In the embodiment of FIGS. 1A through 1C, it is understood that the barrier member between the cooling substrate 28 and the liquid source 42 is the walls of the bladder 48 that rupture or otherwise break to release the liquid. Thus, in this embodiment, separate barrier walls or seals are not formed within the interior space 26 of the shell member 16.

FIG. 4 illustrates an embodiment of a cooling device wherein the opposite panels 18 and 20 define the shell member 16 and interior space 26. In this particular embodiment, the liquid source 42 is provided by compartments 44 formed at the longitudinal ends of the device by an integral barrier 46, such as barrier walls 14, that extend between the inner surfaces of the panels 18, 20. These walls 14 may be formed by any material that breaks or ruptures upon external pressure being applied to the sleeve at the ends thereof to activate the device 10. The walls 14 may be thinned or weakened as compared to the panel members 18, 20 to ensure that they rupture or break prior to compromising the integrity of the panel members.

As discussed in detail above, the shell member 16, particularly the panels 18 and 20, may be formed of various suitable materials. In the embodiment illustrated in FIG. 4, the panel 18 defining the inner face 24 of the cooling device 10 may be a liquid impermeable film. The opposite panel 20 may be a film/nonwoven laminate material wherein the nonwoven component of the laminate defines the outer face 22 that is presented to the user in use of the device. This nonwoven layer 22 presents a soft and compliant surface to the user, as compared to a film. The nonwoven layer may also serve as an insulation layer so that the user's hand is not exposed to the full cooling effect of the device 10.

Still referring to FIG. 4, the cooling substrate 28 with composition 30 applied thereto extends generally along the entire longitudinal length of the shell member 16 and is disposed between opposite material layers 56, 54. As discussed above, various material layers may be included within the interior space 26 to provide desirable thermal characteristics. For example, material layer 54 may be one of the thermally conductive materials described above. Material layer 56 may also be a conductive material, or a material specifically designed to quickly conduct the fluid released from the compartments 44 along the longitudinal length of the device. This material layer 56 may be, for example, a hydrophilic material having channels or other liquid conveying structure embossed or otherwise formed therein.

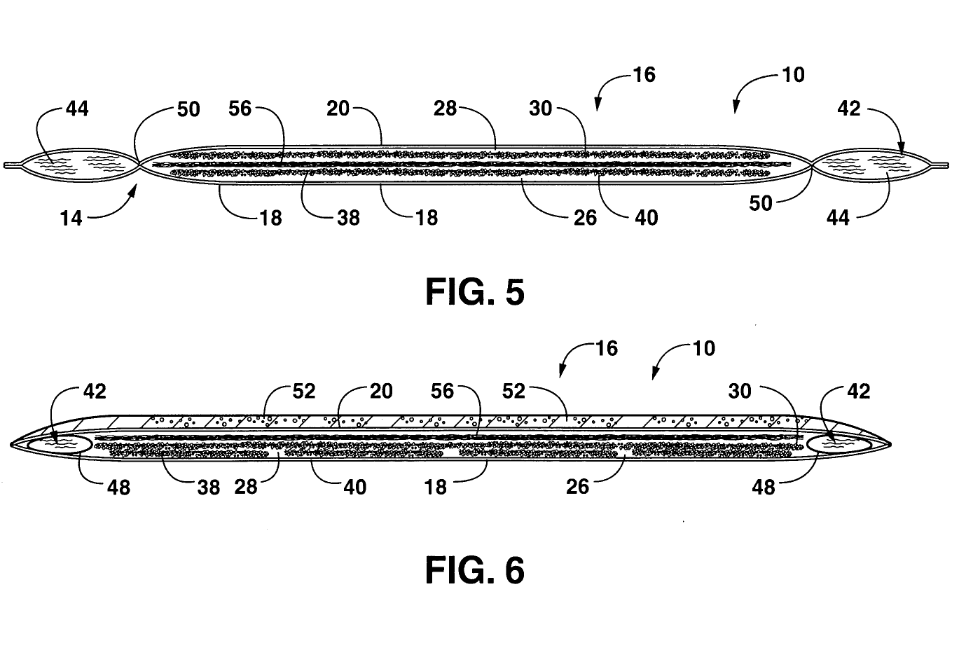

FIG. 5 illustrates an embodiment of a cooling device wherein the liquid source 42 is defined by compartments 44 formed at the longitudinal ends of the shell member 16. The compartments 44 are formed by frangible seals 50 defined between the opposite panels 18, 20. These seals 50 may be formed by welding, adhesive, bonding, and the like, and have a seal strength that is less than the seals between the panel members 18 and 20 at the ends thereof to ensure the integrity of the sleeve member 16. To activate the device 10, a user applies external pressure to the compartment 44 causing the frangible seals 50 to separate and release the liquid contained within the compartments 44.

In the embodiment of FIG. 5, a second cooling substrate 38 is provided with a second cooling composition 40. The second substrate 38 and composition 40 may be identical to the first substrate and composition 28, 30, or may be completely different from the first combination. As discussed above, different combinations of cooling substrates and compositions may be provided within any single cooling device 10 to generate different cooling profiles. In the embodiment of FIG. 5, a material layer 56 is provided between the substrates 28 and 38 and serves as a distribution layer to quickly channel the fluid from the compartments 44 along the longitudinal length of the substrates. The panel members 18 and 20 are formed, for example, of a thermally conductive and liquid impermeable film such that either surface may be applied against the beverage container. Thus, the embodiment of FIG. 5 is reversible and would include an appropriate attaching mechanism at one or both ends of the shell member 16.

FIG. 6 illustrates an embodiment of a cooling device 10 wherein the panel 18 is defined by, for example, a liquid impermeable and thermally conductive film. The opposite panel 20 includes an interior film layer and an insulation layer 52 applied to the outer surface thereof. The insulation layer 52 may comprise, for example, a foam layer, and the entire panel member 20 may be a laminate of the film and foam material.

Still referring to the embodiment of FIG. 6, the liquid source 42 is defined by bladders 48 at the ends of the shell member 16. A first cooling substrate 28 and composition 30 are provided within the interior space 26. A series of second cooling substrates 38 and associate cooling composition 40 are also provided. The second cooling substrates 38 are discontinuous and the associated cooling composition 40 may produce a substantially different set of cooling characteristics as compared to the first cooling substrate 28. A distribution material layer 56 may also be included within the interior space 26 to readily channel and distribute the liquid released from the bladders 48 along the longitudinal length of the shell member 16.

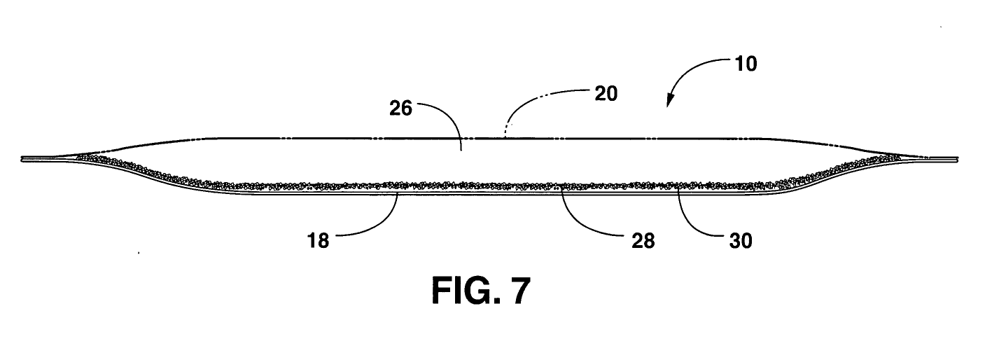

FIG. 7 illustrates a particular embodiment of a panel member 18 that incorporates the cooling substrate 28 as an integral component thereof. In this particular embodiment, the panel member 18 may be a film/nonwoven laminate material, wherein the nonwoven component is coated with the cooling composition 30. Thus, in this particular embodiment, the cooling substrate 28 is not defined by a separate material layer that is disposed between opposite panel members.

The various layers and/or components of the cooling device may be assembled together using any known attachment means, such as adhesives, ultrasonic bonding, thermal bonds, etc. Suitable adhesives may include, for example, hot melted adhesives, pressure-sensitive adhesives, and so forth.

The present invention may be better understood with reference to the following examples.

### EXAMPLE 1

The ability to form a self-activated cooling device for beverage containers was demonstrated. Initially, a dual layer bonded carded web was cut into pieces that measured 6.5 inches in the cross machine direction and 11 inches in the machine direction. One side of the web contained 17 gsm of a 100% 3.0 denier FiberVisions ESC 233 bicomponent (PE sheath/ PP core) fiber with 0.55% HR6 finish. The other side of the web contained 50 gsm of a blend of 50% 15 denier Invista T-295 polyester fiber with 0.50% L1 finish and 50% of a 15 denier FiberVisions ESC bicomponent (PE sheath/PP core) fiber with 0.55% HR6 finish. Therefore, the total basis weight of the dual layer bonded carded web was 67 gsm.

An aqueous coating formulation was prepared as follows. In a 600 milliliter PYREX® beaker, 5.0 grams of VerXan™-D xanthan gum (Cargill, Incorporated) and 295.0 grams of water were mixed and then stirred for about 4 hours. The viscosity of the xanthan gum/ water mixture was measured at about 5100 centipoise using a Brookfield DV-1 viscometer with an LV-4 spindle set at 100 rpm. The mixture was again stirred as 250.4 grams of ammonium nitrate (Sigma-Aldrich, 98+%) were slowly added over about a 10 minute time period. After the addition of ammonium nitrate, the temperature of the formulation dropped to about minus 2° C. and the pH remained essentially constant at about 5.7. After the ammonium nitrate+xanthan gum/water formulation had warmed to room temperature of about 20° C. while stirring, a noticeable decrease in viscosity was evident. Using the same settings for the Brookfield DV-1 viscometer, a viscosity of about 2400 centipoise was measured. The calculated concentration of each component of the aqueous formulation is set forth below in Table 1.

TABLE 1
Components of the Aqueous Formulation

| Component | Calculated Amount |
|---|---|
| Ammonium Nitrate | 45.5% |
| Xanthan Gum | 0.9% |
| Water | 53.6% |

The aqueous formulation was applied to the polyester/bicomponent fiber side of the dual layer bonded carded web using a #60 single wound coating rod. The coated fabric pieces were dried in a laboratory oven at 110° C. for about an hour. The thickness of the coated and dried fabric pieces was measured at 3.45±0.23 mm using a Mitutoyo Digimatic Indicator. The concentration of the components of the coating composition was calculated from the coated and dried fabric pieces (28.9±0.4 grams), the untreated pieces of fabric (3.6±0.1 grams), and the composition of the aqueous formulation. The results are set forth below in Table 2.

TABLE 2
Components of the Coating Composition

| Component | Calculated Amount |
|---|---|
| Ammonium Nitrate | 98.0% |
| Xanthan Gum | 2.0% |
| Solids Add-On Level | ~703% |

A sleeve structure (3.2″×11″) was then designed for activating the cooling reaction. Specifically, the sleeve structure was made with a blown film with a measured thickness of 0.03 mm and a measured basis weight of 41 gsm. The film contained a core layer (94% by weight) sandwiched between two skin layers (6% total weight). The core was made with 100% of Exact 5361, a metallocene polyethylene from ExxonMobil. The skin was made with 88% of LD202.48, a low density polyethylene from ExxonMobil, and 12% of SCC 4837, a titanium dioxide concentrate from Standridge Color Corporation. Four pieces (2.8″×9″) of the coated fabric (total weight of 42.8 grams) were placed inside of the sleeve. The coated side of all four fabric pieces was aligned in the same direction and faced the beverage can (described below). Three water bags (i.e., pouches) were also placed inside of the film sleeve. The water bags were made out of GF-14 medium slip film (a 1.25 mil low density polyethylene film from Pliant Corp.) and filled with 16.4, 16.7, and 17.0 grams of water. The bags were constructed by folding over a 3.5-inch by 2.5-inch piece of the film and heat sealing two edges. The water was then added with a plastic syringe and the third edge was then heat sealed. The final dimensions of the bags were about 1.8 inches by 2.5 inches. Two of the water bags were positioned at the ends of the sleeve and the third bag was situated in the middle and near the top of the sleeve. The film that formed the sleeve was also heat sealed to enclose the coated fabric pieces and the water bags. The final seal was made after evacuating the air from the sleeve using a Fuji Impulse V-300 Vacuum Sealer.

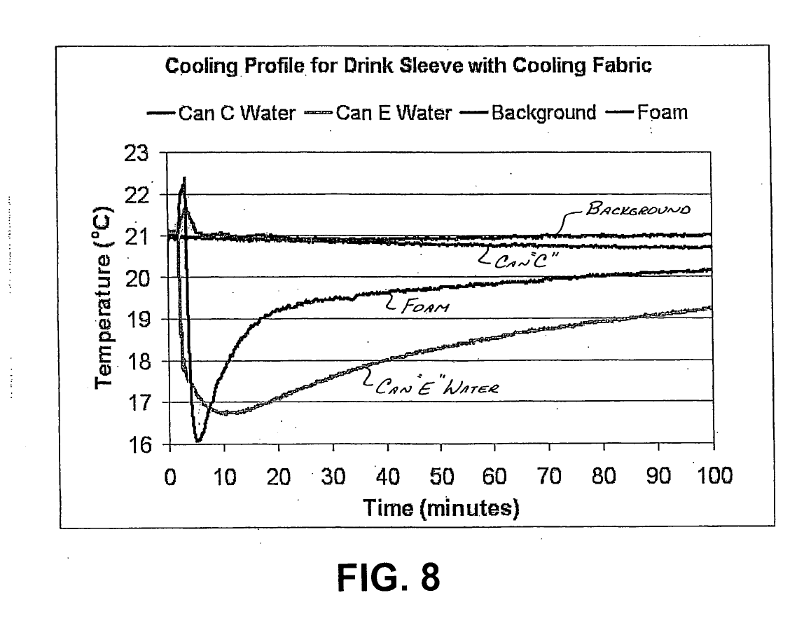

The cooling device (sleeve) was activated by squeezing the three water bags which broke at least one of the heat sealed edges and thus released the water. The coated fabric pieces inside of the sleeve were observed to be immediately wetted by the released water and a quick cooling response was felt. The sleeve was then placed on a 2.8-inch by 9 inch piece of low density, open cell, soft flexible thermoplastic absorbent foam having a measured thickness of 2.8 mm (40% Kraton MD 6932 SEBS type styrenic block copolymer; 50.30% Dow 685D polystyrene; 2.70% Hydrocerol CF-40-T nucleating agent from Clariant Corp.; and 7.0% composition of 60% Cesa-stat from Clariant Corp. and 40% Dow 685D polystyrene) and the sleeve and foam were wrapped together around a Coca-Cola® CLASSIC can (4.9 inches high and circumference of 8.2 inches) (identified as Can “E” in FIG. 8). Two pieces of masking tape (2 inches wide by 5.5 inches long) were used to attach the two ends of the sleeve and foam and thus keep them in place around the can. The sleeve was against the can which contained 200 milliliters (198.5 grams) of water. A Type K thermocouple (OMEGA Engineering, Incorporated) was used to monitor the temperature as a function of time for the water in the can. The thermocouple was carefully placed in the water about 1 inch above the bottom of the can and away from the sides of the can. Data from the thermocouple were collected with a Pico® TC-08 eight channel thermocouple data logger which was attached to a computer. Data were also collected with a second thermocouple for the water in another Coca-Cola® CLASSIC can. This can also contained 200 milliliters (198.4 grams) of water, but did not have a sleeve placed around it (identified as Can “C″” in FIG. 8). Finally, a third thermocouple was placed on the shelf that supported the two cans in order to measure the background air temperature, and a fourth thermocouple was attached to the outside foam layer of the can wrapped with the cooling sleeve and foam. FIG. 8 shows the cooling data. Note that the cooling sleeve was successful at lowering the temperature of the water in the can and maintaining a cool temperature for at least about 20 minutes. Furthermore, it can be seen that the temperature of the foam layer is also reduced immediately after the sleeve is activated. This fast cooling response for the foam layer will allow the consumer to know that the cooling reaction is working. After several minutes the temperature of the foam layer begins to increase quickly, characteristic of the insulator properties of foam.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A cooling device for beverage containers, comprising:
a shell member having dimensions so as to encircle a beverage container, said shell member having an outer face and an inner face disposed against the beverage container in use of said device, said shell member defining an interior space;
a first cooling substrate disposed within said interior space, said cooling substrate comprising an absorbent web having a generally uniform application of a first cooling composition applied thereto, said cooling composition activated by contact with an aqueous liquid;
an aqueous liquid source disposed within said interior space and separated from said first cooling substrate by a barrier member; and
said device activated by manual manipulation to breach said barrier member causing liquid from said liquid source to move within said interior space to contact and activate said cooling composition whereby a cooling reaction is generated.

2. The cooling device as in claim 1, wherein said shell member comprises a closed loop configuration having dimensions such that the beverage container is slid into said shell member.

3. The cooling device as in claim 2, wherein said shell member has sufficient rigidity to maintain its configuration after removal of said beverage container.

4. The cooling device as in claim 1, wherein said shell member comprises a flexible sleeve member that collapses upon removal of said beverage container, said first cooling substrate comprising a flexible material so as to conform with said shell member to the beverage container.

5. The cooling device as in claim 4, wherein said shell member comprises opposite ends, and further comprising an attaching mechanism configured with said ends, wherein said sleeve member is wrapped around and attached to the beverage container.

6. The cooling device as in claim 1, wherein said first cooling substrate has a length so as to fully encircle the beverage container.

7. The cooling device as in claim 1, wherein said first cooling composition has a first set of cooling characteristics, and further comprising a second cooling composition within said interior having a different second set of cooling characteristics.

8. The cooling device as in claim 7, wherein said second cooling composition is applied to said first cooling substrate.

9. The cooling device as in claim 7, further comprising a second cooling substrate disposed within said interior space, said second cooling composition applied to said second cooling substrate.

10. The cooling device as in claim 1, wherein said first cooling composition is an aqueous solution coated onto said absorbent web and includes any combination of cooling agent, a binder, or viscosity modifier.

11. The cooling device as in claim 1, wherein said first cooling composition comprises a particulate cooling agent adhered to said absorbent web.

12. The cooling device as in claim 1, wherein said liquid source comprises liquid stored in a compartment defined within said interior space and formed at least in part by said interior surfaces of said shell member, said barrier member comprising a wall of said compartment that separates or breaks upon manual manipulation of said device to release liquid contained in said compartment.

13. The cooling device as in claim 1, wherein said liquid source comprises at least one bladder inserted into said interior space, said bladder separating or breakable upon manual manipulation of said device.

14. The cooling device as in claim 1, further comprising an insulation material layer adjacent said outer face of said shell member.

15. The cooling device as in claim 1, further comprising a thermal conductive material layer within said interior space disposed so as to direct cold generated in the reaction towards said inner face of said shell member.

17. The cooling device as in claim 1, wherein substantially all of said liquid from said liquid source is absorbed by said cooling substrate so that excess liquid is not held within said interior space after activation of said device.

18. The cooling device as in claim 1, wherein said cooling substrate comprises a separate material disposed within said interior space between interior faces of said shell member.

19. The cooling device as in claim 1, wherein said cooling substrate comprises an interior material layer of said shell member.

20. The cooling device as in claim 1, further comprising a plurality of said cooling substrates within said interior space.

21. The cooling device as in claim 20, wherein each of said cooling substrates generates different cooling characteristics upon activation of said device.

22. The cooling device as in claim 21, wherein each of said cooling substrates comprises a different cooling composition.

23. The cooling device as in claim 20, further comprising a material separator layer between adjacent said cooling substrates.
